(19) United States
(12) Patent Application Publication
(10) Pub. No.: US 2023/0075489 A1
(43) Pub. Date: Mar. 9, 2023

(54) CONTROL SYSTEM

(71) Applicant: Yumpingo Ltd, London (GB)

(72) Inventors: George WETZ, London (GB); Gary GOODMAN, London (GB)

(73) Assignee: Yumpingo Ltd, London (GB)

(21) Appl. No.: 17/896,114

(22) Filed: Aug. 26, 2022

(30) Foreign Application Priority Data
Aug. 27, 2021 (GB) 2112334.4

(51) Int. Cl. G06Q 30/02; G06Q 30/06

(52) U.S. Cl. CPC G06Q 30/0282; G06Q 30/0631

(57) ABSTRACT

A computer implemented method for controlling instances of a process comprising: receiving feedback data on instances of the process, wherein the feedback data comprises a plurality of response values relating to aspects of each process; calculating standard response values for the process based on the feedback data; identifying outliers in the response values for the process in the feedback data from the calculated standard response values; and generating at least one workflow to control and regulate the process based on the identified outliers.

### RELATED APPLICATION

This application claims the benefit of priority of United Kingdom Patent Application No. 2112334.4 filed on Aug. 27, 2021, the contents of which are incorporated by reference as if fully set forth herein in their entirety.

### FIELD AND BACKGROUND OF THE INVENTION

The present invention relates to a computer implemented method and system for controlling a number of instances of a process, in particular for controlling a process for the production of food product.

The control and regulation of processes is important to many businesses across a wide range of sectors, and is particularly important to businesses in the catering, restaurant, and takeaway sectors.

The control and regulation of a process presents several challenges, and it can be especially challenging for businesses when a process is repeated at different locations, which might have different staff and different equipment.

For example, a business may wish to control and regulate a food production process across restaurant locations such that a food product purchased by a customer at one location is substantially the same as the same food product purchased at another location. In such an example there are a number of variables that may lead to differences in the food product produced at the different locations.

It can be particularly difficult to differentiate between issues arising in a product produced by a process due to incorrect implementation of the process i.e an issue with execution, and issues arising in the product because of an inherent flaw in the process. When seeking to control and regulate a process it is desirable to identify execution issues.

It is therefore desirable to develop a method for controlling a number of instances of a process and a system for controlling a number of instances of a process. In particular, when the process is repeated a multitude of times at and over different geographical locations.

### SUMMARY OF THE INVENTION

Aspects and embodiments of the present invention are set out in the appended claims. These and other aspects and embodiments of the invention are also described herein.

According to an aspect of the present disclosure, there is described a computer implemented method for controlling instances of a process comprising: receiving feedback data on instances of the process, wherein the feedback data comprises a plurality of response values relating to aspects of each process; calculating standard response values for the process based on the feedback data; identifying outliers in the response values for the process in the feedback data from the calculated standard response values; and generating at least one workflow to control and regulate the process based on the identified outliers. Such a method advantageously allows the monitoring, control and regulation of a process that is repeated over a number of instances and can identify and rectify instances of the process that have not been correctly executed.

Feedback data is received on instances of the process and comprises a plurality of response values relating to aspects of each process. For example, feedback data is provided on aspects of each instance of plurality of instances of a process. Feedback data may also include the data and time the process was performed and the nature of the process for example the name of the process or the name of the product produced by the process.

The process may produce a product and the feedback data may comprise feedback on products produced by instances of the process and the plurality of response values may relate to aspects of said product. Feedback data on a product produced by a process can be advantageously used to control and regulate the process. Identification of defects or irregularities in the product may correlate to an incorrectly executed process. For example, the product may be a food product and feedback data may be received from the consumers of the food product. The feedback data can then be used to identify and rectify execution issues with the process used to produce the food product.

The instances of the processes may be carried out in different geographic locations, for example different restaurant locations. In more detail each location may repeatedly carry out a process and feedback data on each performed instance of the process may be received from all locations. Receiving feedback from different geographical locations enables the same process performed at these locations to be controlled and regulated so that execution of the process might be standardised across all locations.

Outliers in the response values may be identified by determining a deviation from the standard response values for each response value associated with said process.

The generated workflow may comprise the identified outliers and received feedback data. This can enable a user to create and track actions to control and regulate the process to the calculated standard values. The actions may be automatically generated based on the aspect of the process that the outlier is associated with.

The method for controlling instances of a process may comprise ranking the outliers based on a comparison with the standard value and/or the frequency of the process in the received feedback data.

The method for controlling instances of a process may comprise calculating average response values from the feedback data for one or more variables of interest in the feedback data. For example, the variables of interest may be a location from the different geographic locations and a time period.

Preferably, the method may comprise collecting the feedback data over a time period. For example, feedback data may be collected on instances of process performed over an extended period, such as four weeks.

The method for controlling instances of a process may comprise sending the generated workflow to a user, wherein the workflow enables the user to create and track actions to control and regulate the process to the calculated standard response values. For example, the workflow may comprise a graphical user interface accessible by the user on a computing device. The graphical user interface providing a visualisation of the outputs of the method and below mentioned system. The graphical user interface may provide the user with a visualisation of the identified outliers (execution issues) associated with a process for example associated with an instance or instances of a process.

The method for controlling instances of a process may comprise repeating any one of the preceding steps to generate another workflow from subsequently collected feedback data so as to continuously monitor the control and regulation of the process.

The process may be a food production process. The product may be a food product. For example, the process may be for the creation of a restaurant dish from a recipe.

The method for controlling instances of a process may comprise collecting feedback for instances of a process wherein feedback data is collected using a feedback form comprising questions customised to an instance of the process. Customisation of the feedback form advantageously increases the relevance of collected feedback data. The customised feedback form may be generated from transaction data retrieved from a point-of-sale system.

The method for controlling instances of a process may comprise sending the at least one workflow to a user to control and regulate the process.

Another aspect of the present disclosure is a system for controlling instances of a process, comprising a server comprising a computer program adapted to execute software code to: receive feedback data on a plurality of instances of the process, wherein the feedback data comprises a plurality of response values relating to aspects of each process; calculate standard response values for the process based on the feedback data; and generate at least one workflow to control and regulate the process based on the received feedback data.

The system for controlling instances of a process may further comprise at least one mobile device for generating and collecting feedback data for instances of a process and sending collected feedback data to the server.

The system for controlling instances of a process may further comprise at least one user device for receiving from the server at least one generated workflow to control and regulate the process.

The term food product has been used to mean food and/or drink.

The term customer and consumer are used interchangeably to indicate the person(s) that the service\product has been provided to.

The invention extends to any novel aspects or features described and/or illustrated herein.

Further features of the disclosure are characterised by the other independent and dependent claims.

Any feature in one aspect of the disclosure may be applied to other aspects of the disclosure, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure also provides a computer program and a computer program product comprising software code adapted, when executed on a data processing apparatus, to perform any of the methods described herein, including any or all of their component steps.

The disclosure also provides a computer program and a computer program product comprising software code which, when executed on a data processing apparatus, comprises any of the apparatus features described herein.

The disclosure also provides a computer program and a computer program product having an operating system which supports a computer program for carrying out any of the methods described herein and/or for embodying any of the apparatus features described herein.

The disclosure also provides a computer readable medium having stored thereon the computer program as aforesaid.

The disclosure also provides a signal carrying the computer program as aforesaid, and a method of transmitting such a signal.

Embodiments of the disclosure are described below, by way of example only, with reference to the accompanying drawings.

### BRIEF DESCRIPTION OF THE SEVERAL VIEWS OF THE DRAWINGS

Some practical implementations will now be described, by way of example only, with reference to the accompanying drawings in which:

FIG. 1 shows a flow diagram of a computer implemented method for controlling and regulating a number of instances of a process;

FIG. 2 shows a system for the control and regulation of number of instances of a process;

FIG. 2a shows an example computing system.

FIG. 3 shows a flow diagram of a method for controlling and regulating a number of instances of the production of a food product;

FIG. 4 shows a part of a customer feedback form;

FIG. 5 shows a part of a customer feedback form;

FIGS. 6a and 6b each show a plot of outlier impact;

FIG. 7 shows a part of a generated workflow for controlling a number of instances of the production of a food product;

FIG. 8 shows a part of a generated workflow for controlling a number of instances of the production of a food product;

FIG. 9 shows a part of a generated workflow for controlling a number of instances of the production of a food product;

FIG. 10 shows a part of a generated workflow for controlling a number of instances of the production of a food product;

FIG. 11 shows an overview of analysed feedback data on food product(s) repeatedly produced at a number of locations over a time period; and

FIG. 12 shows a list of example process issues and associated categories.

### DESCRIPTION OF SPECIFIC EMBODIMENTS OF THE INVENTION

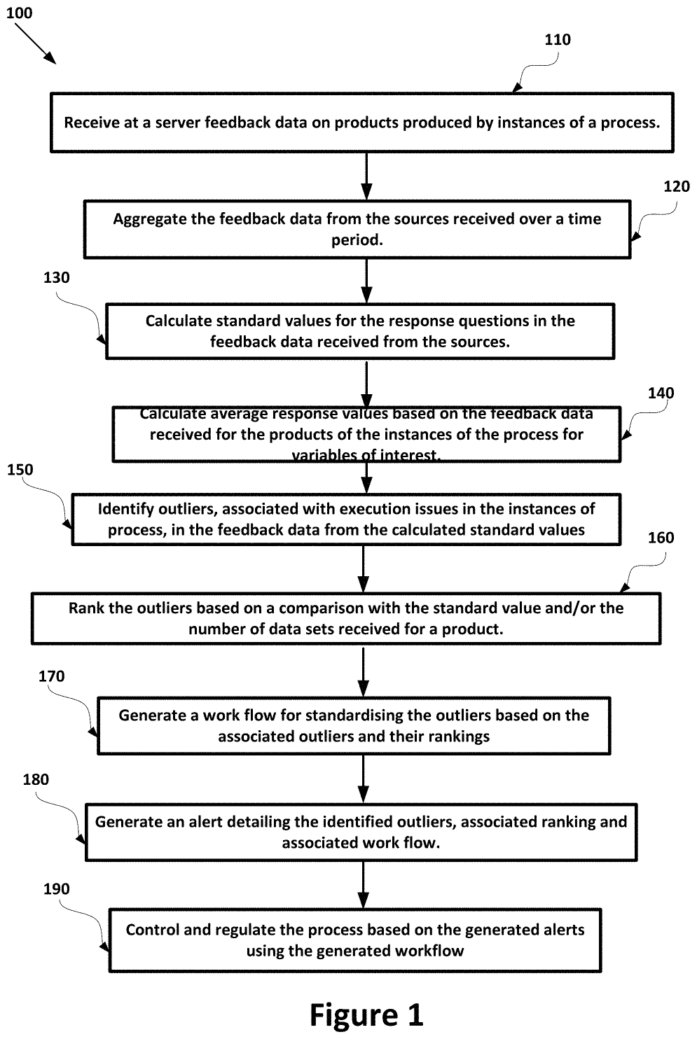

FIG. 1 shows a flow diagram of a computer implemented method for controlling a number of instances of a process for example the repeated production of food product at a number of locations such as is common in the catering, restaurant, and takeaway sectors.

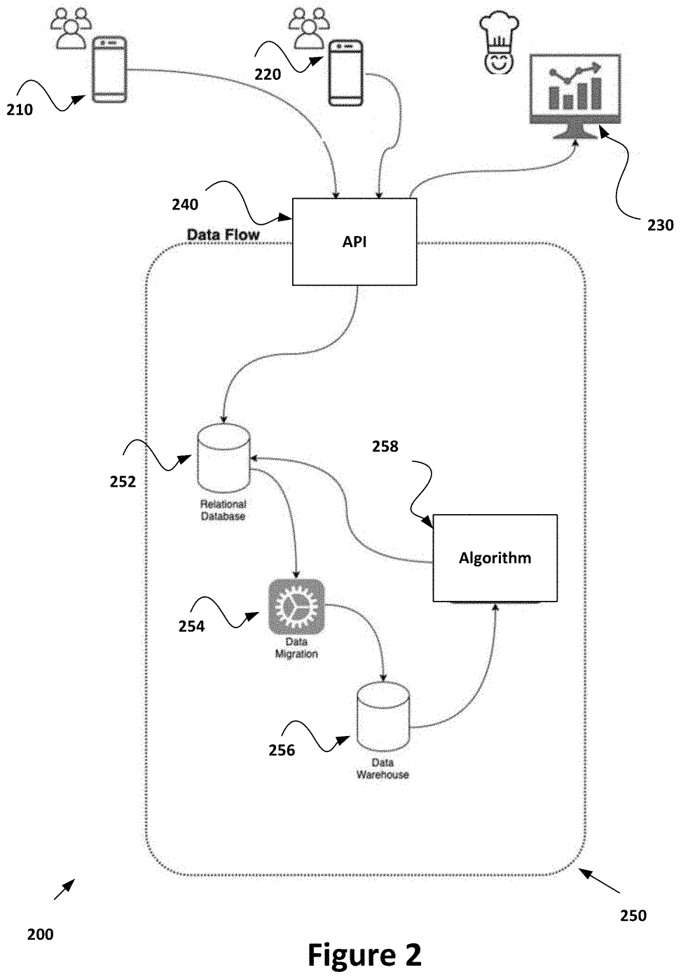

FIG. 2 shows a system for controlling and regulating of number of instances of a process.

Referring to FIG. 2a, the methods disclosed herein are typically implemented on a computer device 1000 or a number of computer devices 1000. In particular, the storing of data and analysis of data by algorithm 258.

The computer device 1000 comprises a processor in the form of a CPU 1002, a communication interface 1004, a memory 1006, storage 1008, and a user interface 1012 coupled to one another by a bus 1014. The user interface comprises a display 1014 and an input/output device, which in this embodiment is a keyboard 1016 and a mouse 1018.

The CPU 1002 executes instructions, including instructions stored in the memory 1006 and/or the storage 1008.

The communication interface 1004 is typically an Ethernet network adaptor coupling the bus 1012 to an Ethernet socket. The Ethernet socket is coupled to a network, such as the Internet. It will be appreciated that any communication medium may be used by the communication interface, such as area networks (e.g. the Internet), infrared communication, and Bluetooth®.

The memory 1006 stores instructions and other information for use by the CPU 1002. The memory is the main memory of the computer device 1000. It usually comprises both Random Access Memory (RAM) and Read Only Memory (ROM).

The storage 1008 provides mass storage for the computer device 1000. In different implementations, the storage is an integral storage device in the form of a hard disk device, a flash memory or some other similar solid state memory device, or an array of such devices.

A computer program product is provided that includes instructions for carrying out aspects of the method(s) described below. The computer program product is stored, at different stages, in any one of the memory 1006, the storage 1008 and/or a removable storage (e.g. a universal serial bus storage device). The storage of the computer program product is non-transitory, except when instructions included in the computer program product are being executed by the CPU 1002, in which case the instructions are sometimes stored temporarily in the CPU or memory. It should also be noted that the removable storage is removable from the computer device 1000, such that the computer program product may be held separately from the computer device from time to time. Different computer program products, or different aspects of a single overall computer program product, are present on the computer devices used by any of the users. The server 250 and computing devices 210,220 may comprise a computing device 1000 or any combination of the hardware of computing device 1000.

To control and regulate a plurality of instances of a process, feedback is collected from a plurality of sources using a generated customised feedback form. The feedback form comprises a series of questions regarding the customers satisfaction with a provided product produced by a process. The questions may be categorised into different aspects of the product provided. For example, in the case of a food product produced by a food production process the consumer may be asked to provide feedback on the “Taste”, “Look”, “Portion Size”, “Value” and their overall opinion of the food product. The feedback is collected from consumers of the product using a computing device 210 for example mobile computing devices 210 for example a smartphone, laptop, tablet etc. The feedback form is presented to the consumer through an application on the mobile computing device 210. Alternatively, the consumer may provide feedback on the product via their own computing device 220 for example a smartphone, laptop, tablet etc. In both cases, the consumer may be provided with a Uniform Resource Locator URL for example a website address so that they are able to navigate to a feedback form flow that is customised to the service that they have received and/or the consumer may access the customised feedback form through an application present on computing devices 210,220 for providing the feedback data.

Once the consumer has completed the feedback form by providing answers to the question on the aspects of the product produced by the process, the collected feedback form data is sent from the mobile device 210,220 to a server 250 for processing. The data may be sent to server 250 via a communication medium such as area networks both wired and wireless (e.g. the Internet), infrared communication, short-range wireless technology etc. Other data associated with the provision of the product is also included in the feedback form data for example the time, date and location at which the product was provided and also details on the product that was provided, for example the name of the product. The feedback data is sent to a remote computing system or server 250 from the mobile computing device 210,220, via for example an Application Programming Interface (API). Server 250 may comprise several networked computer devices 1000, it may for example be provided by a cloud computing solution. Once received by server 250, the feedback data is stored in a relational database 252 in a relational database format for example SQL, allowing it to be analysed by algorithms 258. The feedback data in raw format, formatted relational data structure format and/or an analysed format may be migrated 254 to a data warehouse 256 as a longer term storage solution where it is also accessible to the server 250 for use in analytical algorithms 258.

Feedback form data from a plurality of computing devices 210,220 is collected and transmitted to the server 250 over a time period for example a day, a week, a month etc 110. The feedback data over the selected time period is then aggregated 120 and analysed by the server 250 using algorithm 258. The feedback data over the time period may be aggregated in a number of different ways so as to evaluate and standardise the feedback form data in different ways. For example, the feedback data comprising feedback on a number of instances of a process may be grouped and analysed based on the product provided, the location where the product was provided and where the process was performed, and the time period over which the instances of the process were performed and the products were produced etc.

Once aggregated, an average response value is calculated from the aggregated feedback data for each of the feedback form questions 140. The average response value is calculated based on a variable of interest, for example if the feedback data is aggregated based on location, an average response value for each feedback form question is calculated for each location for the product produced by a process. For example, an average response value may be calculated by taking a mean of aggregated response values at one location for a question, or the average response value may be calculated by taking a median of aggregated responses for a question at that location, or it may be based on a modal value of responses provided in the aggregated feedback data for one location. The average response values can also be calculated in terms of other variables for example the date the product was provided.

To standardise a process, a standard response value\threshold value is calculated 130 for each of the questions\responses on the feedback form from the entire aggregated feedback data received over the time period. The standard response value\threshold value may be calculated by taking an average of the responses provided to each question in the feedback form data for a time period.

For example, a standard response value may be calculated by taking a mean of the responses for a question, or the standard response value may be calculated by taking a median of responses for a question, or it may be based on a modal value of responses provided in the feedback form data.

A standard response value for a question may alternatively be selected independently of the feedback data and provided to the server 250.

Other methods of calculating a standard response value from the feedback form data are also envisaged for example other methods of statistical analysis may be applied to the aggregated feedback data set to obtain a standard value for each question. A standard response value may be also be selected for each question independently of the feedback form data and provided to the server 250. Other methods of calculating a standard response value from the feedback form data are also envisaged for example other methods of statistical analysis may be applied to the feedback form data set to obtain a standard response value for each question.

The calculation of the threshold value/standard response value can also be performed in the following manner. Feedback data for an extended time period (for example two months) is collected for a product produced by a process. The feedback data comprises a number of responses to a number of questions on a product produced by a process This feedback data is analysed and the probability of a response to a question being positive, negative, or neutral is calculated for each question. This probability may be used to determine a threshold or standard response value.

The feedback data is filtered to the feedback data collected from a shorter time period of interest that overlaps with the extended time period (for example a past week or the most recent week of the two month extended time period). This filtered feedback data is analysed to determine whether it comprises a statistically significant sample and analysed to establish the probability of a response to a question being positive, negative, or neutral, and whether the probability of this feedback is a-typical when compared against the pre-determined thresholds. If the determined probability for the data from the shortened time period does not meet threshold and the data is statistically significant then this filtered feedback data comprising responses from the shortened time period is rated a-typical. The instances of the process used to produce the products on which the responses were based are flagged/identified as outliers indicating that there is an execution issues with the execution of the processes. The filtered feedback data may also be filtered to a location where instances of a process were performed allowing the identification of locations with execution issues with the process.

Once a standard response value has been calculated 130 for each question, outlier values, associated with execution issues in the process, in the aggregated\filtered feedback data and associated average response values are identified 150.

The outlier values may be identified using statistical methods for example using the standard deviation of the average response values from the standard response value or the difference of average response values from the associated standard response value.

The identified outliers may then be ranked based on a comparison with the standard response value 160. For example, the outliers that deviate from the standard response value by the greatest magnitude may be ranked as highest priority and the outliers that deviate from the standard response value by less may be assigned a lower priority.

Alternatively, or in addition feedback form data may be collected for a plurality of products each produced by a different process in this case the outliers may be assigned a ranking based on the number of feedback form data sets received for that product produced by the process for example a higher number or frequency of feedback form data sets for a certain product may indicate that the product is popular and it may therefore be appropriate to assign the outlier a higher priority value than other outliers that are associated with less popular products.

For example, as part of the execution algorithm 258 popularity and severity metrics may be produced for each execution issue discovered. These metrics may be calculated specific to each location, using the percentage of reviews and a weighted sum of the logarithms of the responses in the constituent rating categories, for the popularity and severity respectively. The executions issues are then sorted into the discrete brackets of “small”, “medium” and “high” severity and popularity and a comparison to the rest of the feedback data collected at the other locations and sorted in the same way is made.

A workflow is generated for standardising the identified outliers to the standard value 170. The generated workflow provides a series of actions to be undertaken to standardise the identified outliers of the product.

An alert, comprising information on the outliers and the workflow is generated by the server 250 and is sent 180 to a computing device 230 of a user associated with the provision of the process. For example, to a user's mobile computing device 230. The generated workflow may be accessible to the user through a URL for example a web link or through an application on a computing device.

To control and regulate the instances of the processes that the user is responsible for, the user that receives the alert performs the actions that are detailed in the workflow to rectify the execution issues associated with the process 190. Alternatively, or in addition the workflow provides the analysed feedback form data including information pertaining to identified outliers to the user so that the user may create a series of actions themselves to control and regulate the process so as to eliminate execution issues with the process and the associated identified outliers. The actions may be stored and tracked, for example in the workflow and in the database associated with the server 250 so that the user can mark them as completed when the actions are completed. Furthermore, the system also stores the generated standard and average response values so that they might also be used to track when an execution issue with a process is resolved. Storing the analysed outputs and feedback data in this manner allows the effectiveness of actions taken to resolve execution issues to be determined. For example, if an execution issue is identified in a process and an action to resolve the execution issue performed then analysis of subsequent feedback data can be used to identify if the performed action resolved the execution issue in the process.

A series of workflows may be generated over consecutive time periods so that progress in the resolution of execution issues associated with a process can be monitored. For example, the method 100 may be repeated over a number of time periods to create a feedback system for the resolution of execution issues associated with a process. Feedback form data may be collected continuously from customers on different instances of a process and continuously received by the server or servers 250. The on-going analysis of the process in this manner advantageously allows prompt identification of aspects of a product of a process that deviate from a standard and provides a method of tracking and fixing these deviations so that standardisation of the process might be achieved across all instances.

An advantage of the above described method for controlling and regulating a process is that the method can differentiate between execution issues and product development issues. For example, burning food is an execution issue, but bad packaging design or an inherent fault in the process is a product development issue. This is important because the individual locations might only be able to resolve the former, not the latter. As the process to be repeated is identical, for example comprising the same steps, there should be no outlier values in the product response values if the process is executed correctly at each instance. Identification of outliers in the manner described above, for example against a threshold or standard value, enables the identification of execution issues in the process.

As noted above it can be particularly challenging to control a process that is repeated and provided at different geographical locations. Production of a food product is a process that it is often desirable to control\standardised so that consumers can repeat purchases of food product at different locations and at different times knowing that the purchased food product will be substantially similar to previously purchased food products i.e there are is no difference in the execution of the process used to produce the food product.

Furthermore, food production often follows a set process that is repeated to ensure each time a food product is made it is substantially the same as other food products made using that process. However, poor execution of this process can result in a food product that differs from others made using the same process. It is therefore important to identify instances of the process where there have been execution issues so that these issues may be resolved.

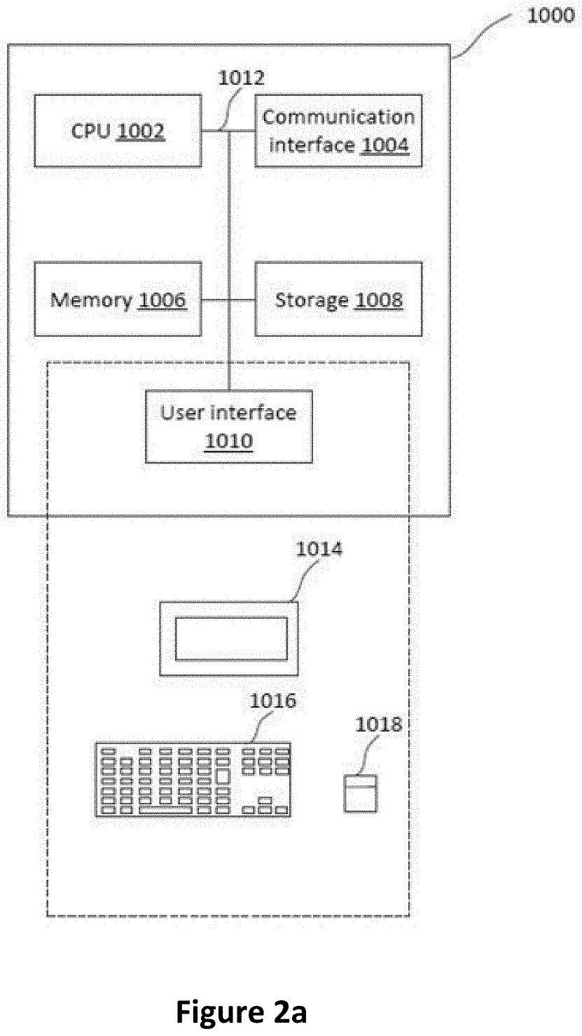

FIG. 3 shows an example of the method 100 of FIG. 1 for controlling the repeated production of food product across different geographical locations. The system 200 of FIG. 2 is used to perform the method 300 of FIG. 3.

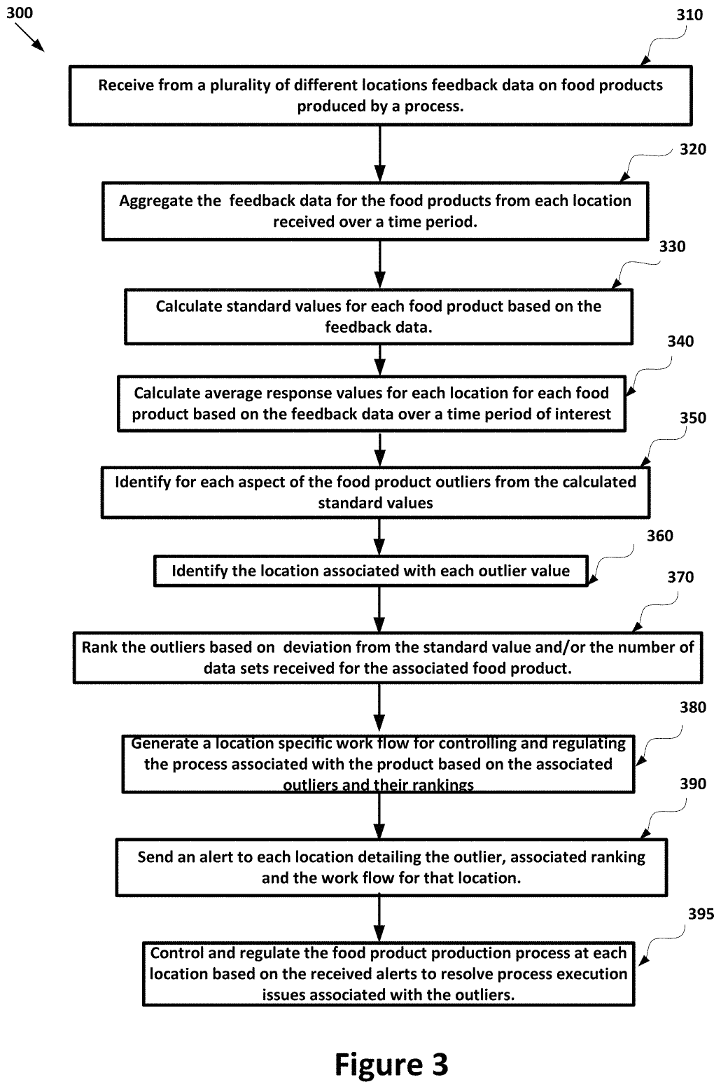

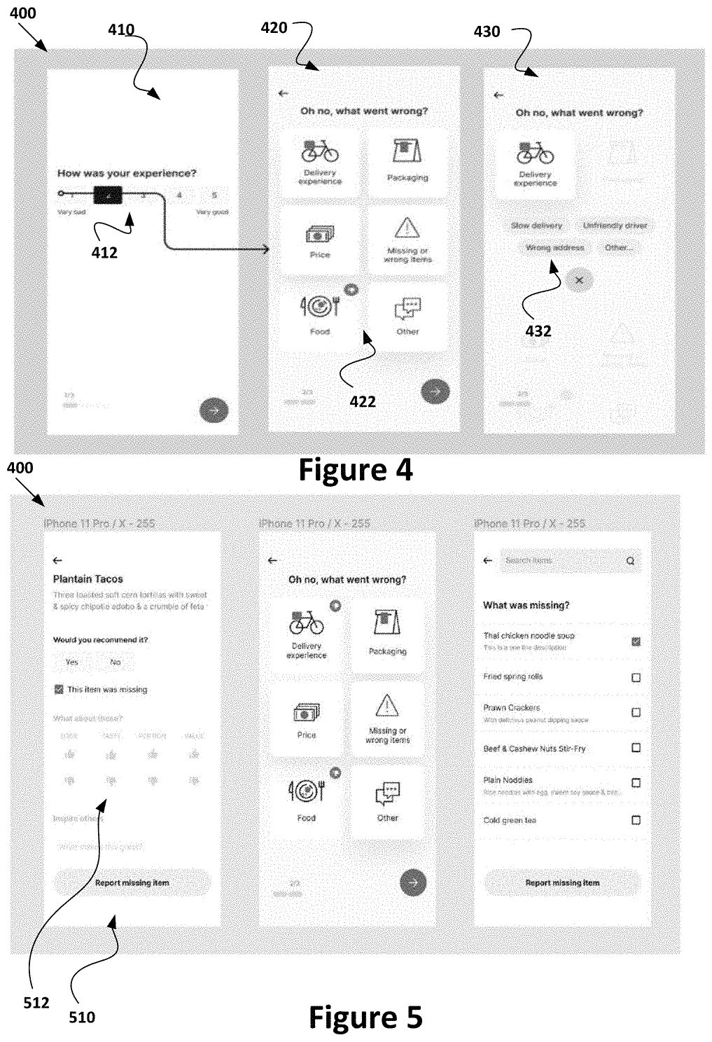

A restaurant chain or food outlet provides customers, who have purchased food product, with a mobile device 210 such as a tablet or mobile phone on which to complete a feedback form. An example of a generated feedback form 400 is shown in FIGS. 4 and 5. Alternatively, the customer may be provided with instructions to access a web link on their own mobile device that directs them to a feedback form 400. For example, a matrix barcode that contains instructions to access a web link may be provided to the customer or for example the customer/consumer might be sent an email/SMS/push notification to their mobile device that contains a URL. Alternatively, or in addition the customer may be presented the survey inside another application, for example a feedback form generator or presenter may be included in an order and pay application in which the customer may be presented with the feedback form after paying for their meal. In either case the feedback form 400 may be personalised to the products, in this case the food products, that the customer has purchased. For example, if the customer has purchased a cup of coffee and a cheese sandwich the personalised feedback form would include questions specific to those food products. This may be achieved through integration of the application or webpage providing the feedback form with a point of sale system and/or an ordering application. Alternatively, the customer may select from a list of food products (services) the food product(s) that they have purchased and the feedback form 400 presents customised feedback questions on the selected food products.

Additional functionality may be provided through this integration with the point of sale system and customisation of the feedback form for example the questions on the feedback form may be customised to the issues that typically occur in a particular location. For example, a location may have been identified previously as having an issue with food product being too spicy. A feedback form for this location may be customised to comprise a question specifically on the spice level of food product provided by that location. Or for example, if a location has an issue with music being too loud, the feedback form may be customised to ask the consumer about the noise level. The feedback form questions can therefore be customisable (both manual and dynamic) and customisation of the feedback form in this manner, be it dynamic or manual enhances the accuracy and relevance of the feedback data collected.

FIG. 4 shows an example feedback form 400 that is made available to a customer who has purchased food product and has had the food product delivered to them. The feedback form may be generated by server 250 and made available at the local computing device or it may be generated locally at the mobile computing device. In either case the computing device that generates the feedback form has access to transaction data so as to customise the generated feedback form to the purchased products. For example, the server or mobile computing device might connect to the point of sale system responsible for the transaction The customer is provided with instructions to access the feedback form 400 on their mobile device 210, and having navigated on their mobile device to the feedback form 400 using the provided instructions the customer is asked to respond to a core question 412 regarding their experience with the service, in this case the customer is presented with the core question “How was the experience” on screen 410 of FIG. 4. The core question 412 provides feedback on the customers overall experience.

Following the customer response to the core question 412 the customer is then presented with a set of options\categories 422 shown onscreen 420 of FIG. 4, on the aspects of the service or services and food product(s) that were provided. The options 422 presented to the customer may depend on the response to the core question 400. In this case where the customer has indicated that they were unhappy with the service. Following the core question 410 the feedback form 400 presents the customer with a number of different categories 420 of the service that may have been at fault for example “Delivery Experience”, “Packaging”, “Price”, “Missing or Wrong Items”, “Food” and other. The customer is asked to indicate which of the categories 422 were responsible for the negative experience. Once the customer has indicated which categories were responsible for the negative the feedback form 400 presents the customer with category specific questions to indicate the specific issue with the service. For example, if the customer has indicated that the delivery experience was at least part of a reason for the negative experience the specific issues 432 on which the customer is asked for feedback might include “slow delivery”, “unfriendly driver”, “wrong address” such as those shown in screen 430 of FIG. 4.

In more detail, the feedback form 400 comprises a number of questions regarding the service that has been provided. The questions are categorised together into categories 422 depending on which part of the service they relate. For example, questions such as “Is the food undercooked” might be categorised as relating to food preparation whereas a question such as “Were you slow to be seated” might be categorised as speed of service.

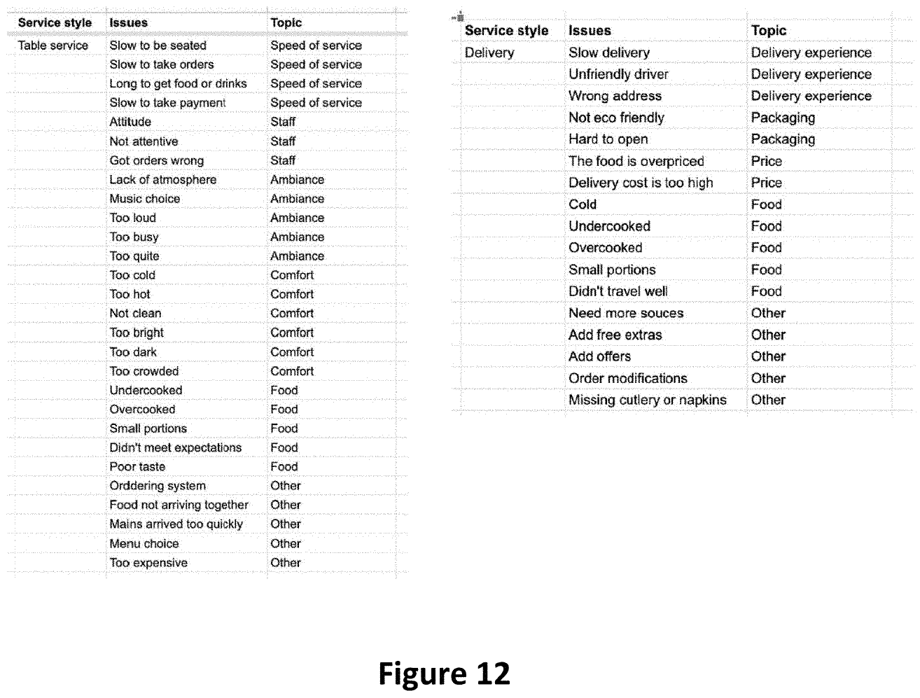

Furthermore, the feedback form may be populated with different categories and questions depending on whether the food has been delivered to the customer for example as a take away service or if the customer purchased and consumed the food product in the restaurant. In the latter case questions relating to table service such as “Were you slow to be seated\How fast were you seated” would be appropriate. Example questions that are used to populate customised feedback form are given in FIG. 12.

A further example of the feedback form 400 that may be presented to the customer is shown in FIG. 5. These screens 510,520 and 530 may be presented to the customer in the same feedback session as other feedback form screens for example those shown in FIG. 4, the sequence shown in FIG. 5 may follow sequentially from the screens shown in FIG. 4.

The feedback form screens of FIG. 5 indicates that the customer has recorded a negative response to the core question 412. The customer has then indicated via selection of the food category from categories 422 that a food product that they received was at least partially responsible for the negative response.

After providing these responses the customer is then invited to indicate what specifically about the food product(s) resulted in a negative experience. This invitation may be in the form of a contextualised feedback form based on the food product purchased\ordered by the customer. Information is obtained via integration of the application or webpage presenting the feedback form to the customer with a point of sale system. In the example shown in FIG. 5 the customer ordered “Plantain Tacos” and indicated in a previous screen of the feedback form dissatisfaction with the food product. The feedback form screen 510 shown in FIG. 5 requests that the customer indicate their satisfaction with different aspects of the specific food product “Plantain Tacos”. In this example the potential issues 512 that are presented to the customer and which the customer is invited to provide feedback on are the “look”, “taste”, “portion” and “value” of the food product, the customer is also asked to provide feedback on their overall opinion of the food product. In this manner feedback on the food product produced by a specific instance of a food production process is collected from the consumer. Whilst only one example of a feedback form relating to food product is shown the customer may be invited to provide feedback, in a similar format, on all the food products that they have purchased. A feedback form can collect data on a number of instances of different processes that have produced a number of different products. This feedback data is then communicated to the server for analysis.

The issues\questions presented to the customer for feedback on a food product may be varied depending on the food product and are not limited to those in described above.

The feedback form screen 510 of FIG. 5 also invites the customer to indicate whether they would recommend the food product to others.

Furthermore, in the case of FIG. 5 the food product was delivered to the customer and the customer is asked if the issue with the food was that the food product was missing when they received delivery.

The feedback form screens shown in FIGS. 4 and 5 are examples and the customer may be presented with a number of screens so that feedback may be collected on different categories\aspects of the service and the potential issues that may be associated with them.

The examples shown in FIGS. 4 and 5 relate to a food delivery service provided to a customer. A similar feedback form can be used to collect feedback on restaurant services provided to a customer and the associated food products provided to a customer at a restaurant. For example, such a feedback form may start with similar core question of “How was the experience”. If the response to this core question 410 was negative or non-optimal the customer would then be presented with a screen to indicate the categories that were responsible for this negative or non-optimal response. In the case of restaurant service, a feedback form similar to that shown in FIG. 4 may be presented, however it would be populated using different or additional aspects for example aspects of the service on which feedback might be required in a restaurant context might be “Speed of service”, “Staff”, “Ambiance”, “Comfort”, “Food” and “Other”. In a similar manner to that described above in reference to FIGS. 4 and 5, once the customer has indicated the categories that were responsible for the negative or non-optimal response to the core question 410 the feedback form flow will present the customer with feedback forms generated to collect feedback on specific issues associated with those aspects. For example, the customer may indicate that the “Ambiance” was at least partially responsible for the negative or non-optimal response, following this the feedback form flow presents the customer with a screen similar to that of FIG. 4, 430, but populated with issues specific to Ambiance for example “Lack of atmosphere”, “Music Choice”, “Too loud” and “Too Busy”.

Alternatively, the feedback form 400 may present the aspects of service for feedback and associated issues independently of the customer's response to the core question 410.

Another important aspect of a service in the catering, restaurant sector, and takeaway sectors is the customer experience. Standardisation of customer experience is also highly desirable so that a customer has substantially the same experience every time they purchase a service or when they purchase a service from different locations. For example, it is desirable to standardise the ambiance of different restaurant locations.

Consistency of service is yet another area in which standardisation is important. It is often the case that food outlets have a number of steps of service to ensure that the customer has a good dining experience. Steps of service might include asking if the customer requires cutlery and any condiments. Ensuring that these steps of service are being met consistently across different locations for all customers presents another challenge and is another important aspect of standardising a service offering.

The feedback form may also include questions as to whether particular steps of a service have been completed by the restaurant or delivery staff for example the feedback form may contain a series of questions on the steps of service that were provided for example if the customer was offered sauces and cutlery with their meal. The series of questions on the steps of service may precede the core question 410 and the presentation of these questions to the customer may be independent of the customer's response to the core question 410.

In the example questions shown in FIG. 5 the customer is invited to indicate with a binary choice of approve\satisfied (thumbs up) or disprove\dissatisfied (thumbs down) whether they were satisfied with the subject of each of the generated issues 510. The customer may alternatively or in addition be presented with a graded scale for example 1-10 or 1-100 with how satisfied with the subject of each issue for example a customer very satisfied with the music choice might record a 100 score for music choice but a customer very unsatisfied with the atmosphere may record a score of 1 for that issue.

In such a way a feedback form can, in addition to collecting feedback on a product produced by a process the feedback form can be used to collect information from a customer about a service that has been provided and in particular collect detailed information on specific issues relating to different categories or aspects of that service. In particular the feedback form is customisable to different types of guest experience available at the same location. For example, restaurants or food product retailers often offer multiple different service styles simultaneously, such as table service, off the shelf purchase and delivery. The feedback form enables the identification of specific issues with each of these service styles, adding further relevance in addressing issues associated with each of the service styles as well as providing feedback on food product produced by a process.

Once the information has been provided by the customer on either their own mobile device 210 for example through a weblink or an application or on a mobile device provided to a customer 220. The feedback data is sent 310 to a remote computing system or server 250, via for example an Application Programming Interface (API) 240.

Additional data is also included in the feedback data for example the details of the service provided to the customer in this case might include the food product(s) that were ordered, the location they ordered from\consumed in and the date and time the order was made. This additional data is included in the feedback data in addition to the responses provided by the customer. The feedback data received by the server 250 is stored in one or more relational databases 252 where it may be accessed and analysed using analytical algorithms 258.

To allow statistically meaningful analysis of services and food product(s) produced by different instances of a process, data is collected using the feedback forms detailed above from a number of different customers over a time period for example a week or a month.

Once a statistically meaningful feedback data set has been collected the feedback data can be grouped\aggregated\filtered for analysis 320. For example, in this case where the control of multiple instances of a food production process across different of locations is of interest, the feedback data is grouped based on food product, and location (a variable of interest). From the collected feedback form data, a standard response value for the food product is calculated by the server 250 and also standard response values for each of the issues associated with the food product that were presented in the feedback form 330. An overall response value for each location is also calculated based on the customer response to the core question 410 which is in this example “how was your experience”.

For example, within a time period of a month 100 feedback forms may have been received from a location. Out of the 100 feedback forms, 80 may have recorded a positive experience when asked “how was your experience” about a food product for example “chips”. Out of the 100 feedback forms 20 may have recorded a negative response and associated that with the chips that were served. Furthermore, out of these 20 negative responses 10 may have indicated that the portion size was unsatisfactory and 5 may have indicated that the taste of the food was unsatisfactory.

The standardised core response value may be calculated by taking an average of the responses to the core question 410 provided across all locations from which feedback forms relating to the food product were received. The standard response value may be calculated by taking an average of the responses for a food product provided across all locations. A standard response value for the issues\questions associated with the food product may also be calculated by taking an average of the responses for that food product issues\questions provided across all locations. For example, out of 1000 feedback forms associated with a specific food product for example “Chips” received from 10 different locations, 200 may have recorded negative responses associated with the “Chips” that were provided. Using this data, a standardised value for the specific food product may be determined. The standardised value may be calculated in a number of different ways, one method for calculating the standardised value is to calculate the percentage of the responses associated with the food product that received a positive or non-negative review in this example the standardised value would be 80%. Similar standardised values may be calculated for the core response and food product issue response. For example, in the case of the issue response value, if out of the 200 negative reviews, 50 of the responses indicated an issue with the portion size of the product the standardised value\threshold for this issue would be 95%. In the case of the standardised core response value if, for example, a total of 10000 feedback forms had been received, and out these 1000 contained negative or non-optimal responses to the core response, a standardised core response value would be 90%.

Other methods may be used to calculate standardised values\threshold for example, a standard value may be calculated by taking a mean for example a weighted mean of aggregated values in a category, or the standard value may be calculated by taking a median of aggregated values in a category, or it may be based on a model value of responses provided in the aggregated feedback data. Other methods of calculating a standard value from the aggregated data are also envisaged for example other methods of statistical analysis may be applied to the aggregated data set to obtain a standard value.

A standardised value for responses may be selected independently of the feedback data and provided to the server, for example there may be a desire to set a specific standard value which all instances of a process must reach.

Once standardised values have been set or calculated for food products and associated issues, the average response values for the food product are calculated for each location 340. This calculation is performed in a similar way to the calculation of the standardised value above but is calculated and averaged over each location separately and optionally the feedback data is filtered to data collected in a shorter time period that overlaps with the time period (for example a past week or the most recent week of the two month extended time period) rather than the entire data set. In more detail, continuing the example detailed above, out of the 1000 total responses associated with the food product “Chips” received from 10 locations collected over the last month, 100 of these responses may have been associated with one location, Location A and collected in the last week. Out of the 100 response received for the question in relation to “Chips” at Location A, 50 may have been negative responses, resulting in a response value of 50% for this question, which is below the standardised value of 80%. A different location, Location B, may be associated with a different 250 responses out the 1000 total responses. Out of 250 Location B responses to the same question, 25 may have been negative resulting in a response value for Location B of 90% which is above the standardised\threshold value of 80%.

A similar calculation may be used to calculate the issue response values for the food product and core response value for each location. As noted above other statistical methods could be used to calculate the core response value, response value and the issue response values. In particular where the feedback form has requested a score on a graded scale, for example 1-10 or 1-100, instead of a binary (satisfied or dissatisfied), other statistical methods may be more appropriate for calculating the standardised values and the response values. For example, the customer might be asked via the feedback form how satisfied with the food product they were on a scale of 1-100 and in addition the customer may be asked to grade the associated issues in a similar manner.

Following calculation of the average response values the algorithm identifies for each aspect of the food product outliers from the calculated standard values 350 and the location associated with each outlier value identified 360.

Average response values that are below the standardised value are identified and flagged by the algorithm 258 as outlier values 350. In this example, the feedback form data has been grouped and analysed by location and food product and may additionally be grouped by a shortened time period. The “Chips” served at Location A over the last week have a response value lower than the standardised value and this response value is therefore labelled as an outlier. The “Chips” at Location A may also have an issue response value lower than a standardised issue value, in this case the issue response value would also be labelled as an outlier value, indicating a persistent execution issue in the execution of the process to produce “Chips” at Location A in the last week The average response value calculated for the “Chips” food product at Location B was higher than the standardised value, the average response value for Location B is therefore not considered an outlier, indicating no or minimal execution issues with execution of the process used produce “Chips” at Location B in the last week. Whilst the average response value for Location B is not identified as an outlier it is possible that at least one of the average issue response values for “Chips” is lower than the corresponding standardised issue response values, where this is the case the issue response values that are lower than the standardised issue response values are also labelled as outliers.

Other methods of identifying outliers can also be used. For example, outliers may be identified as average response values or average issue response values that deviate from the standardised values by an absolute value or a percentage of the standardised value. For example, response values that deviate from the standardised\threshold value by 10% may be chosen to be labelled as outliers.

It is desirable to rank the outliers in an order in which they should be addressed so as to bring the associated average response value or average issue response value into line with the corresponding standardised response value by for example addressing the execution issue in the process that resulted in the poorly executed food product. The outliers may be ranked based on deviation of the outlier response value from the standard value and/or the number of data sets received for the associated food product 370.

One method of ranking outliers is to rank the outlier values based on severity which is the amount by which the average response value of the outlier deviates from the standard response value in combination with the overall popularity of the food product. The popularity of a food product is calculated by the server from the received feedback data including the associated data for a time period by determining from the data the percentage of the total number of food products that comprised the food product in question. For example, out of 1000 feedback data forms 500 may be associated with an order for the food product “Chips” and 250 may be associated with an order of “Hamburgers”. In such a feedback data “Chips” would be considered to be more popular than “Hamburgers”.

The outliers are grouped into low, medium and high impact groups for both severity and popularity. For example, top third most popular food products are grouped into the high impact group for popularity, the bottom third of food products in popularity are grouped into the low impact group for popularity and the middle third of food products in popularity are grouped into the medium impact group for popularity. Similarly, with regard to severity, the outliers are grouped into low, medium and high impact groups depending on the amount by which they deviate from the associated standard response value. For example, the top third of outliers that deviate the most from their corresponding standardised response values are grouped as high impact for severity, the bottom third of outliers in terms of deviation from the standardised response value are grouped as low impact in terms of severity, and the middle third are grouped as medium impact in terms of severity. The combination of an outlier's popularity grouping and severity grouping determines their overall ranking or impact grouping. For example, an outlier value that is low impact for severity and popularity is ranked as having a low overall ranking\impact, an outlier value that is high impact for severity and popularity is ranked as having a high overall ranking\impact and an outlier value that has a high impact for severity and low impact for popularity is ranked as having a medium overall ranking\impact.

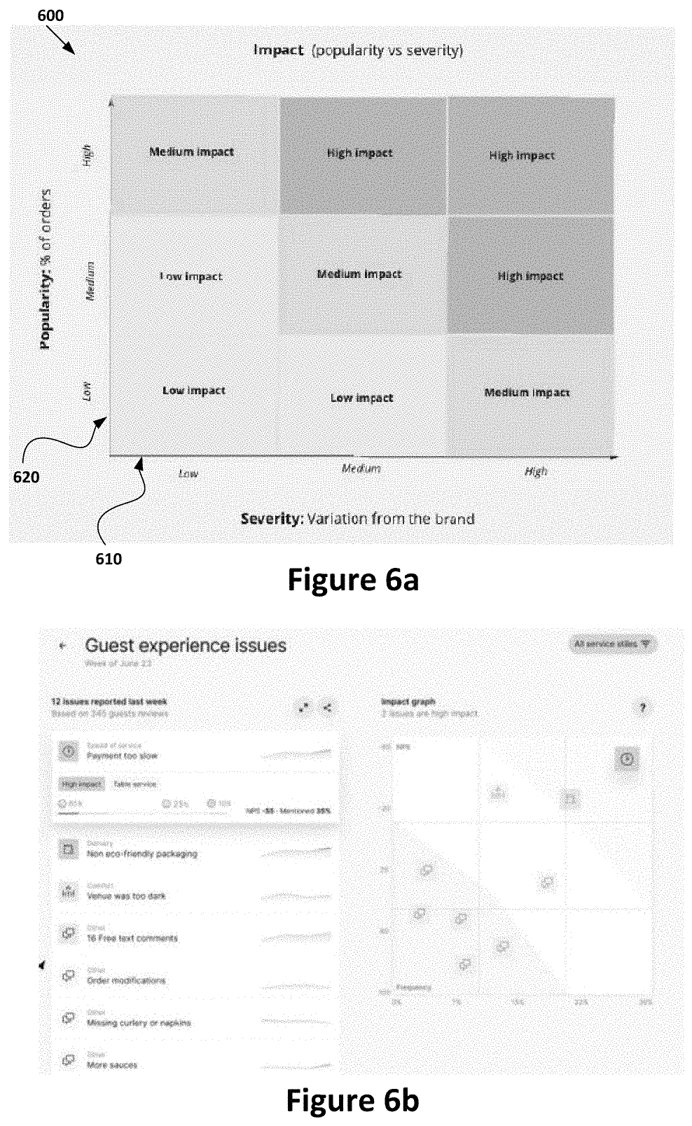

FIG. 6a shows a plot 600 of outliers ranked using this method. The x-axis 610 of the plot 600 is severity of the outlier, and the y-axis 620 is the associated popularity of the outlier (percentage of orders). The x-axis 610 and y-axis 620 are each divided into three equal sections (low impact, medium impact and high impact) to create a grid 630 comprising nine areas corresponding to an outliers overall ranking\impact based on the combination of the severity and popularity groupings.

The above analysis has been described applied to feedback data on food product. A similar analysis can be performed on other aspects of the service on which feedback data has been provided.

For example, an analysis of this type of whether certain steps of a service, such as offering cutlery to the customer, have been consistently provided can be useful in standardising the service across different locations and highlighting locations where there is non-compliance with the standardised service. In such an example, the standardised response value may be calculated in similar many as described above or chosen such that the step in the service is always expected to be completed.

Once average response values and outlier rankings have been calculated the data is then analysed by the algorithms 258 to generate a workflow for each location 380. The workflow is generated to assist staff at the locations to standardise the food product or food products from that location to the standardised values.

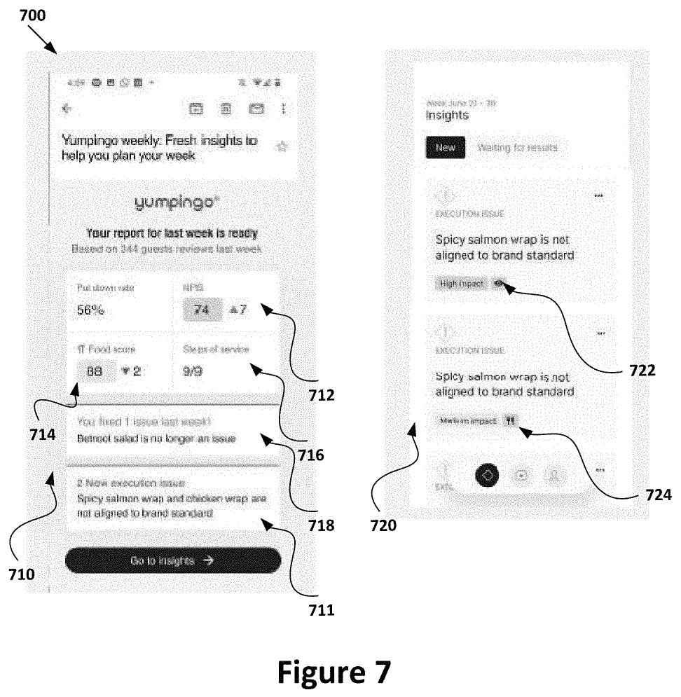

FIG. 7 shows an example workflow 700 generated from feedback form data and analysed as described above. The workflow is accessible via a weblink or application on computing devices for example a mobile computing device. Once a workflow 700 for a location is generated a notification\alert is sent to a mobile device or email address of a staff member responsible for service at that location for example a restaurant manager. The notification may contain a URL that directs a user to the web accessible workflow and/or notifies the user that the workflow is available for review via for example an application.

The workflow 700 shown in FIG. 7 is based on feedback form responses collected over a time period for example the four weeks prior to the generation of the workflow. As noted above the standardised response values are calculated over the time period in this case four weeks but in this example the average response values are generated based only on feedback data collected in the one week prior to the generation of the workflow. Each week the feedback data may be processed in this way and the end user provided with a reminder email summarising the identified execution issues for the prior week and providing access to a generated workflow. The end user can login into an application or webpage comprising a dashboard and see the alerts associated with outliers. Alternatively, or in addition, the processing of the feedback data may be continuous so that the end user can access real time feedback on the process.

An alert is sent to a user at each location detailing the outliers associated ranking and the workflow for that location 390.

The workflow shows an initial screen 710 that summarises the results of the analysis of the feedback data for a specific location over a past week. The initial screen 710 shows the number of feedback forms received in the time period, the calculated core response value 712 for the location, an averaged food product value 714 and the completed steps of service 716. The averaged food product value is an average of the response values for all food product responses at the location. The completed steps of service indicates if the feedback data forms comprised any outliers associated with a step of a service.

The initial screen 710 alerts the user to execution issues 714 with food product by highlighting food products which are associated with outlier values that should be addressed. The initial screen 710 also highlights current execution issues and food products with outlier values from a previous workflow report that have now been standardised 718. In the example shown in FIG. 7, the initial screen 710 of the workflow 700 highlights 711 that the “spicy salmon wrap” and the “chicken wrap” food products had calculated average responses that deviate from the standard response values for these food products.

The workflow 700 enables the user to navigate to detailed information on the response values associated with the highlighted food products. In this example, the user selects the food products that have been highlighted and navigates to the screen 720 shown in FIG. 7.

FIG. 7 shows a screen 720 comprising the outlier response values for the two food product that have been highlighted. In this case, “the spicy salmon wrap” has been identified to have a high impact outlier 722 associated with the “look” of the food product and also has a medium impact outlier 724 associated with the “taste” of the food product. The look and taste of the “spicy salmon wrap” at this location has therefore been identified as having an execution issues associated with the process used to produce these food products at this location over the past week. There is therefore a need to address these execution issues with the food production process so that the produced food products do not result in outlier values.

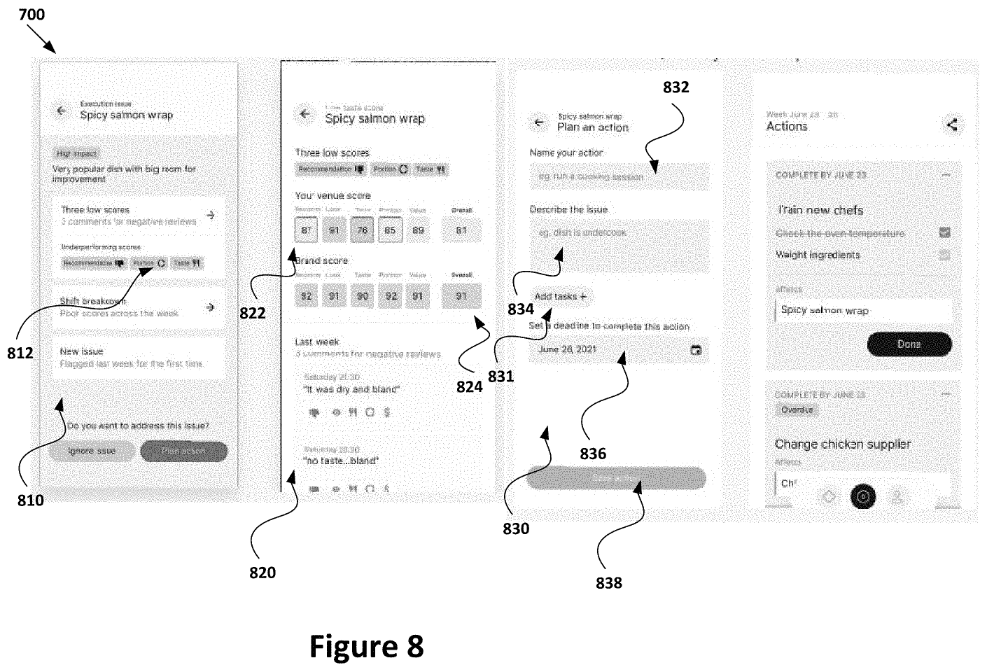

FIG. 8 shows a further workflow screen 810 accessible to the user comprising the average response values 812 for the “spicy salmon wrap” comprising the average response values for “Recommendation”, “Look”, “Taste”, “Portion” and “Value”. Screen 810 also shows the associated standardised response values 814. The calculated response values are colour coded to indicate divergence from standardised value for example for a large divergence from the standardised value the calculated response value is shown in red, where there is no divergence or where the calculated response value is an improvement on the standardised value the calculated response value is shown in green. Also highlighted are the response values identified as high impact outliers 812 in this case “Recommendation”, “Taste” and “Portion”. A further full breakdown of the average response values 822 for the “spicy salmon wrap” and corresponding standard response values 824 is shown in workflow screen 820.

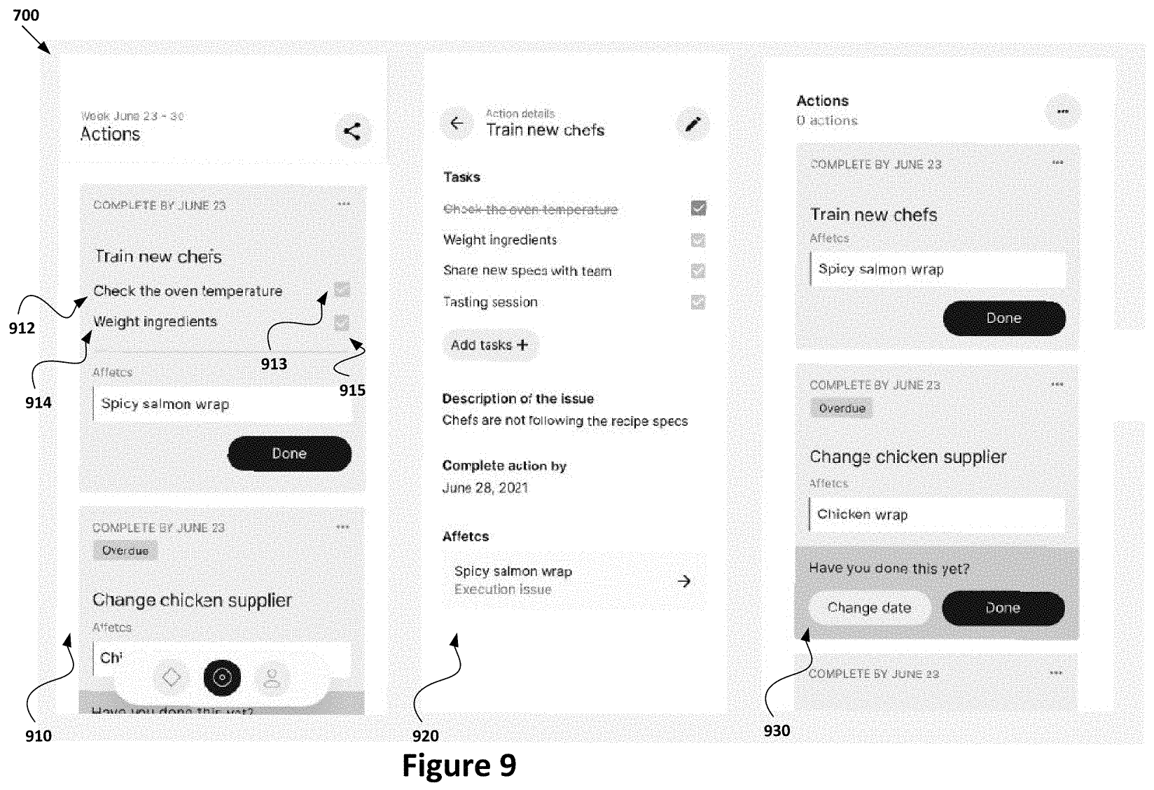

Following from a review of the detailed screens for the average response values to the food product questions, the user is invited to plan an action to rectify the execution issues that have been identified with the food production process used to produce the food product. An example of the template screen 830 available to plan an action is shown in FIG. 8. The action template 830 invites the user to give the planned action a name 832, describe the issue 834, add tasks to be completed 836, to set a deadline to complete the action by 838 and to add tasks 831 required to complete the action. Once the user has filled out these details they are invited to save the action 830 so that it may be tracked in the workflow 700. FIG. 9 shows an example of an action set by a user associated with the execution issues that were highlighted with the “spicy salmon wrap” food product. In this example, the user has an action “Train new chiefs” 910 which comprises changes in the preparation of the dish and maintenance of the equipment used to prepare the dish, specifically the action comprises two tasks: “checking the oven temperatures” 912 and “weighing ingredients” 914. Both “checking the over temperatures” and “weighing the ingredients” have associated check boxes 913,915 that the user is to complete once the task has been carried out. The actions seek to resolve the execution issues identified in the process used to produce the food product. The user controls and regulates the food product production process at each location based on the received alerts to resolve process execution issues associated with the outliers 395.

FIG. 9 shows further examples of actions created by the user in workflow screens 920 and 930. In addition, actions may be automatically generated in the workflow based on the identified outliers. For example, an outlier associated with taste may automatically generate an action and task to “Check cooking equipment”. In such a way the execution of the food production process is alerted so as to produce a food product consistent with food product produced by other instances of that food production process.

Actions may also be created either by the user or automatically generated for categories other than food product for example steps of service. For example, the average response value for “were you offered cutlery” may be identified as an outlier that does not meet the associated standard response value and an action to retrain service staff on this point automatically generated.

After a time period the user will receive and/or be notified of a new workflow report subsequently generated a week after the workflow shown in FIGS. 7 to 9. The subsequent workflow is based on average response values calculated from feedback form data collected in the week following the generation of the workflow 700 shown in FIGS. 7 to 9 and standard response values calculated from feedback form data collected over a time period for example a preceding month. As with the workflow 700 of FIGS. 7 to 9 the subsequent workflow highlights poorly executed food products having average response values that have been labelled as outliers. The workflow also provides a comparison with the workflow of the preceding week and in particular the workflow highlights food products that were successfully standardised during the week and provides a reminder of the food products from the previous week that are still identified as outliers and which therefore have persistent execution issues with the associated food production process. The non-completed actions from the previous week are also retained in the workflow so that they may be actioned. Having received the subsequent workflow the user repeats the process described above in relation to FIGS. 7 to 9 so as to create and complete actions to standardise food product and other aspects of the service at the location they are responsible for.

Further information may be provided in the workflow 700. For example, FIG. 6b shows a workflow screen 650 that comprises an impact plot 660 of popularity\frequency against severity of outliers 662 associated with guest experience issues. Also provided on workflow screen 650 is a list of plotted outliers 664 with each outlier 662 in the list detailing the feedback data that was used to calculate the outlier. In more detail, the first listed outlier relates to the guest experience issue of table service and specifically “payment being too slow”. Detailed in this listed outlier are the ranking or impact of the outlier and the percentage of negative, neutral and positive responses relating to this issue.

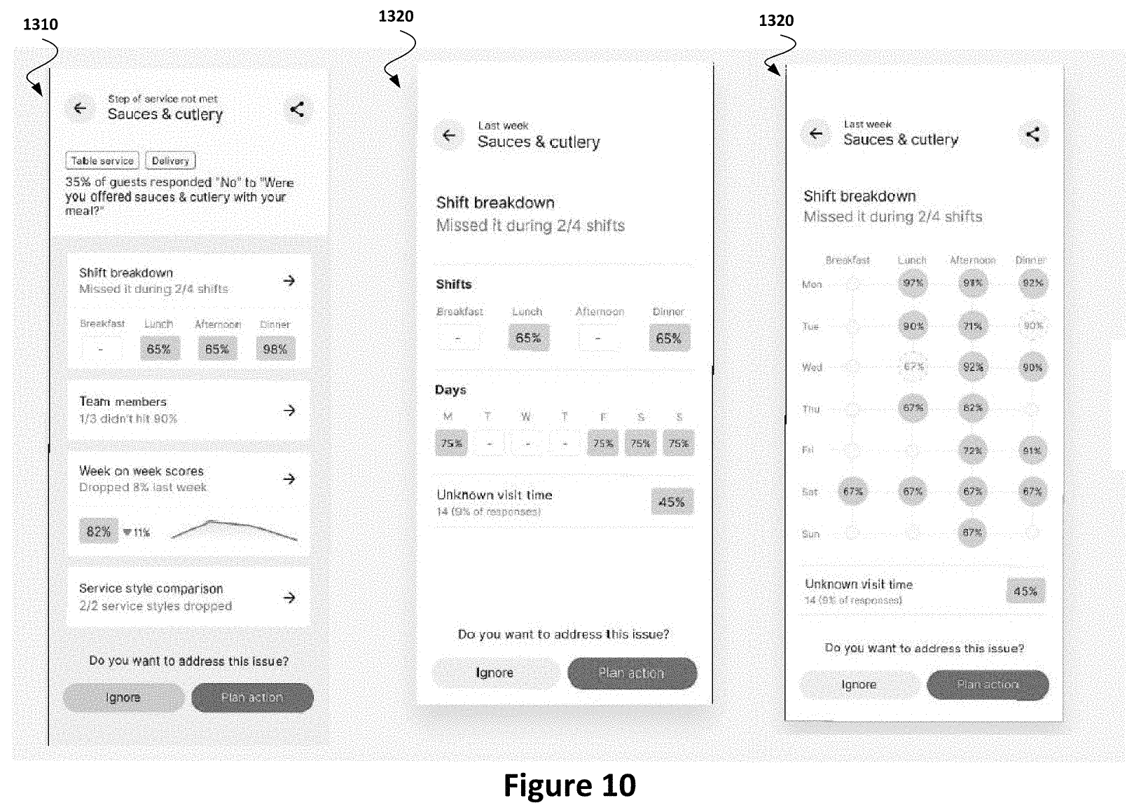

A further series of workflow screens 1310, 1320 and 1330 is shown in FIG. 10. These workflow screens may be included in the workflow 700. The workflow screens 1310, 1320 and 1330 relate to analysed feedback data on steps of service for this location. Workflow screen 1310 highlights that a step of service “offering of cutlery and sauces” did not meet the standard value for the time period and has been identified as an outlier. Further, information regarding this outlier is provided in workflow screens 1020 and 1030 that show a breakdown in terms of time and date (or restaurant staff shift) as to when responses relating to this this step of service were submitted. It is therefore possible to identify during which shifts the step of service was being met, i.e the average response value was in-line with or above the standard response value and it is possible to identify during which shifts the step of service was not met, i.e. the shifts that the average response value was below the standard response value and identified as an outlier. In this breakdown the average response value for each shift is calculated by taking the average of the response values received during that shift at that location rather than over the entire time period. Another workflow screen, not shown, shows a similar breakdown as screens 1320 and 1330 but in terms of the staff that were present during these shifts. On each of these workflow screens 1310, 1320, 1330 the user is invited to plan an action to standardise this step of service in a similar manner as described above in workflow 700. The additional information provided aids in the creation of the action for example the user may identify a shift a staff member when the average response value falls below the standard response value and create a specific action to talk to the staff members on that shift.

The breakdowns for the steps of service shown in FIG. 10 can also be generated for all other response values. For example, it could be used to identify if outlier average response values for a certain food product were consistent across shift times and staff or if there was a particular shift or staff member that was incorrectly executing the process. Thus, allowing the user to identify when execution issues with the associated food production process occur.

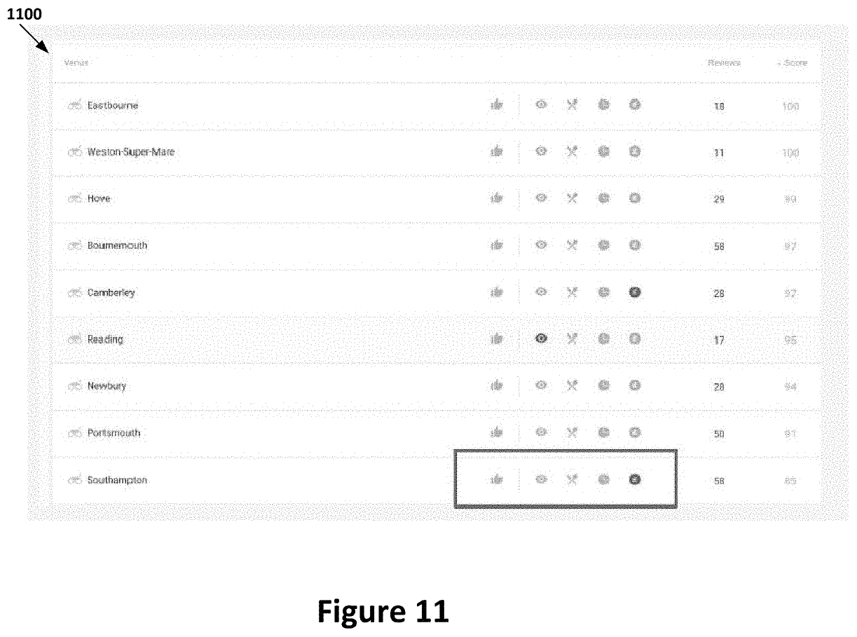

FIG. 11 shows an overview of analysed feedback data received for all locations over the time period. It lists locations and displays colour coded symbols that represent the response values for food products averaged over all food products for which feedback data was received. Red indicates an average response value that is significantly below the standard value, yellow an average response value that is below the standard response value and green an average response value that meets or exceeds the standard response value. For example, a location in Southampton is highlighted as this location has been identified to be underperforming, i.e not meeting the standard response value for “recommendation”, “look”, “taste”, “portion” and “price” for its food products. In this overview the standard response value for each of these issues is calculated from the average response value from all locations and all food products.

The overview screen 1100 may be provided to a user who is response for an area comprising several locations and allows identification of locations that are underperforming and where action n is required. In particular, such overviews provide insight into issues that are not addressable at the individual location level, for example they may not relate to the execution of the process but the issues instead are related to product development, for example a need to alter the process for the production. This may for example be indicated by a low standard value for a food product across all locations. These insights can be used inform their next cycle of product development.

As noted above a variety of statistical methods may be used to calculate the standard and average response values. Furthermore, there are a number of ways in which feedback data may be analysed and stored. For example, analysed feedback data may be retained on a database of the server for use by the algorithm at a later date, it is particularly useful to retain outlier data and threshold data so that in future workflow reports a user can determine the progress made in standardising a process for example if outliers from previous workflows have persisted. There are a number of ways in which a relational database, database and algorithm may analyse, store and manipulate data to achieve such functionality. One example of how the algorithm\computer program might store, analyse, manipulate and present the feedback data is as follows:

For every identified outlier (execution issue) an insight message (alert) is generated (in the workflow), listing properties and characteristics relevant to the user (frontend). The properties and characteristics may be flagged as execution issues in the database in which they are stored.

Every insight message either stems from an execution issue or a follow-up message. If the same product\process attracts both an execution issue and a follow-up message, only the execution issue is sent, as it contains all of the relevant information/overrides the previous execution issue. All flags pertaining to the old execution issue are set to or, since the new execution issue message (like every execution message) contains all response fields for that product for example (“Overall, Look, Taste, Portion, Value”) in three arrays (‘flagged’, ‘unflagged’, ‘unknown’). (“Overall, Look, Taste, Portion, Value”) may be abbreviated to (o, l, t, p, y).

Every insight message contains an object, which specifies which flag has which status.

Every flagged characteristic will be followed up in subsequent weeks, deciding whether this flag has reoccurred, or has been unflagged (a characteristic\property\response field may be unflagged if it is no longer identified as an outlier in the most recent feedback data), or whether the recent feedback data is statistically significant to update the status this week. This again results in insight messages to be sent to the Frontend (for example a user device for example contained in a generated graphical user interface).

Follow-up will be iterated in subsequent weeks, for as long as the characteristic reoccurs or there is not enough data to make a determination. Every week a new table of follow-ups will be created from last week's flags with non-terminal and non-temporary states, and be concatenated with the newly found flags. Over time, a flag can have any of the following statuses:

Initial state of every flag in the week where all flags are persisted and followed up on. If the feedback data on the relevant outlier is statistically significant in a subsequent week to determine that the outlier has been standardised (for example if the average response value is in line with the threshold\standard value) then the flag for this outlier (execution issue) is unset. This is a terminal state for the outlier and insight message.

If the feedback data was not statistically significant for this outlier (for example a response value for a specific food product) then a decision is made whether to flag or unflag the outlier. This is determined based on if a rating category has been or last week and is this week. This is only a temporary state that exists between the follow-up message creation task and the execution issue message creation task; its purpose is to tell the execution issue that its message status needs to be, not (see below for the difference between message status and flag status). No flag with this status should ever be saved.

If a rating category (response value) is this week, then all other (or) rating categories for the same product are set to. This is to ensure that they do not result in a follow-up message, because there will already be an execution issue message containing these flags. This is a temporary status inside the follow-up message creation task; no flag with this status should ever be saved or passed to the execution message creation task.

If a flag has been on for a number of weeks (current default: four), the follow-up is ceased and set it to this status. It can happen, if for example a product is taken off the menu, or if there is nobody ordering it in this location for several weeks (due to for example seasonal variation). This is a terminal state.

Follow-up of any non-terminal state is performed on the old flags by looking at the table of new probability values (for example average response values), adding a column containing statuses “, “, “, and joining to the table of historic flags.

The full schema for a batch of insight messages is the following:

javascript
{
“insights”: [
{
“type”: “execution”,
“createdAt”: “2021-02-28T06:42:31”,
“atom”: {
“type”: “dish”,
“id”: “1000”,
“entity”: “venue”,
“entityId”: “1234”
},
“from”: “week beginning”,
“to”: “end of week”,
“status”: “reflagged”,
“priority”: {
“reach”: “high”,
“severity”: “low”,
“impact”: “high”,
“rank”: 0.689789
},
“analysis”: {
“characteristics”: {
“flagged”: [“o”],
“unflagged”: [“p”],
“unknown”: [“l”, “t”, “v”],
“stale”: [ ],
“historical”: [“o”, “l”]
}
}
},
{...}//next insight message
],
“batchId”: “12345456”
}

For a follow-up message, the object is missing.

Every execution issue message has a ‘priority’ object, packaging the bracket for ‘severity’, ‘popularity’, ‘priority’ (i.e. low/medium/high), also referred to as ‘severity’, ‘reach’, ‘impact’. The absolute value for the priority rank and ranking is included in the the workflow so the user can order them descending for every location.

Every insight message has a status, which is slightly different from flag status:

If an insight message comes from an EI, then the status is either or. If it is the latter if any of the characteristics flagged this week were either flagged or unknown last week (from a previous flagging). This means, if a product was flagged for ‘ol’, for ‘tpv’ last week, and is for ‘tpv’ this week, then this week's execution issue message has status, not. This is the reason for the distinction of and for the follow-up flags.

If an insight message comes from a follow-up, its array must be empty.

If a follow-up message contains any characteristics (alongside possibly others in the and arrays), its status is.

If a follow-up message contains only unflagged characteristics, its status is.

If a follow-up message contains only stale characteristics, its status is.

If a follow-up message contains stale and unflagged characteristics, it is.

Every insight message contains an array listing all characteristics that are historic, i.e. those that it has been flagged for over $$N$$ weeks preceding this one (current default: $$N=4$$, the value of N may be varied.

Execution issue follow-up of old flags will take the current, go seven days back, read in all files with the prefix of that date, and discard all locations for which it is not the report time. The last statement is only true if running in—in do not run once per time zone: we only create one per day, so no time zone filtering necessary.

Every execution issue will result in an insight message, listing properties and characteristics relevant to Frontend.

All execution issues in one week may be plotted onto the unit square (by their rank in the severity and the popularity table) such as that shown in FIG. 6b.

As part of the execution algorithm popularity and severity metrics for each execution issue discovered are produced. These metrics are calculated at the venue level, using the percentage of reviews and a weighted sum of the logarithms of the p-values in the constituent rating categories, for the popularity and severity respectively. When these issues are ranked they are binned into the discrete brackets of “small”, “medium” and “high” and a comparison is made to other products\processes. All severity and popularity scores are treated as independent draws from some underlying distribution each, and the discrete binning characterises their position in this underlying distribution: pooling all scores from a location only may not yield usable estimates for the bin boundaries high/medium and medium/low because there is not enough data. Instead, a given issue in a given location is “high severity for this product, typically” etc. Given that there are not infinitely many independent samples from the score distributions, the estimates for the bin boundaries come with an uncertainty—in order to perform the binning in a consistent way, this uncertainty should be roughly the same for different time zones (time periods)—hence the requirement that ranking and dividing should be done on roughly similar data volumes (i.e. all issues across a product). This is the only point in the pipeline where the algorithm needs to see a pool of issues larger than one location.

All execution algorithm runs on a certain UTC date will save their flags and issues into the a bucket for example a S3 bucket.

One prefect result object per run that spits out flags/issues. They can be read in as s via
python
res=S3Result(prefix=prefix)
flags, issues=res.read(filename).value

For the production runs, is (month and day are zero-padded)

The has the pattern, where is the time the flow ran (not the)

Execution issue follow-up of old flags will take the current, go seven days back, read in all files with the prefix of that date, and discard all venues for which it is not the report time.

The last statement is only true if running in—in it is not run once per time zone: only create one per day, so no time zone filtering necessary.

This means that when rerunning, it is important to delete the objects from the S3 buckets beforehand. Otherwise, there are two instances of the same (or similar . . . ) flags and issues in the folder of that day. These will, seven days later, create two follow-ups and potentially send two insight messages to the API belonging to the same location/product/week or any combination thereof. An appropriate thing to do is to just remove the entire prefix and rerun all time zones for that day.

There are also results created in and: these are likely coming from checkpointing.

The above examples are to be understood as illustrative examples. Further examples are envisaged. It is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A computer implemented method for controlling instances of a process comprising:
receiving feedback data on instances of the process, wherein the feedback data comprises a plurality of response values relating to aspects of each process;
calculating standard response values for the process based on the feedback data;
identifying outliers in the response values for the process in the feedback data from the calculated standard response values; and
generating at least one workflow to control and regulate the process based on the identified outliers.

2. The method of claim 1, wherein the process produces a product, and the feedback data comprises feedback on products produced by instances of the process and wherein the plurality of response values relate to aspects of said product.

3. The method of claim 1, wherein the instances of the processes are carried out in different geographic locations.

4. The method of claim 1, wherein identifying the outliers comprises determining a deviation from the standard response values for each response value associated with said process.

5. The method of claim 1, wherein the generated workflow comprises the identified outliers and feedback data.

6. The method of claim 5, wherein the actions are automatically generated based on the aspect of the process that the outlier is associated with.

7. The method of claim 1, comprising ranking the outliers based on a comparison with the standard value and/or the frequency of the process in the received feedback data.

8. The method of claim 1, comprising calculating average response values from the feedback data for one or more variables of interest in the feedback data.

9. The method of claim 3, comprising calculating average response values from the feedback data for one or more variables of interest in the feedback data, wherein the variables of interest are a location from the different geographic locations and a time period.

10. The method of claim 1, comprising collecting the feedback data over a time period.

11. The method of claim 1, comprising sending the generated workflow to a user, wherein the workflow enables the user to create and track actions to control and regulate the process to the calculated standard response values.

12. The method of claim 1, comprising repeating the receiving, calculating, identifying, and generating steps to generate another workflow from subsequently collected feedback data so as to continuously monitor the control and regulation of the process.

13. The method of claim 1, wherein the process is a food production process.

14. The method of claim 2, wherein the product is a food product.

15. The method of claim 1, comprising collecting feedback for instances of a process wherein feedback is collected using a feedback form comprising questions customised to an instance of the process.

16. The method of claim 15, comprising retrieving transaction data from a point of sale system to generate a customised feedback form.

17. The method of claim 1, comprising sending the at least one workflow to a user to control and regulate the process.

18. A system for controlling instances of a process, comprising a server comprising a computer program adapted to execute software code to:
receive feedback data on a plurality of instances of the process, wherein the feedback data comprises a plurality of response values relating to aspects of each process;
calculate standard response values for the process based on the feedback data; and
generate at least one workflow to control and regulate the process based on the received feedback data.

19. The system of claim 18, comprising:
at least one mobile device for generating and collecting feedback data for instances of a process and sending collected feedback data to the server.

20. The system of claim 18, comprising:
at least one user device for receiving from the server at least one generated workflow to control and regulate the process.
